(19) United States
(12) Patent Application Publication
(10) Pub. No.: US 2025/0273016 A1
(43) Pub. Date: Aug. 28, 2025

(54) Transaction Processing Using Surface-Penetrating Radar

(71) Applicant: GPR, Inc., Somerville, MA (US)

(72) Inventors: George JORDANIDES, Westwood, MA (US); Byron STANLEY, Newton, MA (US)

(21) Appl. No.: 18/859,330

(22) PCT Filed: Apr. 28, 2023
(86) PCT No.: PCT/US2023/066385

§ 371 Date: Oct. 23, 2024

Related U.S. Application Data
(60) Provisional application No. 63/335,835, filed on Apr. 28, 2022.

(51) Int. Cl. G07B 15/00; G01S 7/00; G01S 13/88

(52) U.S. Cl. CPC G07B 15/00; G01S 7/006; G01S 13/885

(57) ABSTRACT

A vehicle-borne system that includes a surface-penetrating radar (SPR) system is disclosed. The SPR system acquires SPR images and includes at least one antenna for RF communication with an external device. The vehicle-borne system includes a transaction module that obtains information via the SPR system from the external device that specifies a transaction. The vehicle-borne system includes a controlled that includes a processor and electronically stored instructions that are executable by the processor. The controller computationally generates responsive information for completion of the transaction and causes the responsive information to be transmitted to the external device.

### FIELD OF THE INVENTION

The present invention relates, generally, to consummation of transactions involving a vehicle.

### BACKGROUND

Payment transactions involving vehicles or their locations are numerous. These include highway tolls, parking meters, traffic violations, fuel purchases and, more recently with the advent of electric vehicles (EV), charging fees. Traditionally, payments have been made manually by giving cash to a toll taker or purchasing a parking coupon for display behind the vehicle's windshield. Although many of these transactions have been automated to certain extents, doing so often requires additional vehicle-borne equipment (such as a toll transponder) or separate dedicated applications each linked to a source of payment.

Moreover, unless linked to some form of location service, transaction-processing applications that involve the location of the vehicle (parking, for example) require additional steps by the driver to establish the vehicle's position and effect payment. Yet tying transaction payment to acquisition of location through, for example, the satellite-based Global Positioning System (GPS) risks the increasing threat of GPS spoofing. This occurs when a radio transmitter is used to send a counterfeit GPS signal to a receiver antenna to override a legitimate GPS satellite signal. Most navigation systems are designed to use the strongest GPS signal, and the fake signal overrides the weaker but legitimate satellite signal. GPS spoofing may be particularly attractive to thieves when used to support payment transactions.

Accordingly, there is a need for systems and methods permitting contemporaneous acquisition of vehicle location and payment for a transaction, and which address the risk of spoofing or other means of electronic theft.

### SUMMARY

Embodiments of the present invention use surface-penetrating radar (SPR) both to establish vehicle location as well as to perform the wireless communications necessary to complete a payment transaction. Systems in accordance herewith may be linked to a driver's digital wallet, and may supply the current location of the vehicle, if appropriate, as part of the payment process. An advantage of SPR in obtaining location information is its utility in environments, such as cities, where multipath or shadowing degrades GPS accuracy, or as an alternative to optical sensing approaches that cannot tolerate darkness or changing scene illumination, or whose performance can be adversely affected by variations in weather conditions. Payment transactions facilitated through a SPR system is also difficult to spoof. Whereas GPS is satellite-based, an SPR system generally lies beneath a vehicle, residing just inches above unique and challenging-to-spoof ground signatures, making the signal substantially inaccessible to malefactors.

In various embodiments, a sensor underlying the road surface interacts with the SPR antenna array to process the payment transaction; that is, the SPR system not only uses radar signals to characterize terrain and thereby determine vehicle location, but also to supply data (which may be encrypted) to identify the payer and payment source to the buried sensor and authorize the transaction. In other embodiments, overhead gantries or roadside transmitters emit radiofrequency (RF) signals that are reflected off the road surface (or a plate that enhances reflection) and received by the SPR array to initiate the payment transaction, which may be completed in various ways. In one approach, one or more of the SPR antennas is angled relative to the ground so that reflected signals can reach the overhead gantry or a roadside receiver. In another approach, the array is constructed to produce enough diffraction around the edges to allow an outgoing signal to be received by an external receiver. In still another approach, the transaction is completed via a different communication modality (e.g., the vehicle's cellular data system) or via a separate antenna.

In various embodiments, a vehicle-borne system may include a surface-penetrating radar (SPR) system for acquiring SPR images, the SPR system may include at least one antenna configured for RF communication with an external device; a transaction module for obtaining information via the SPR system from the external device specifying a transaction; and a controller including a processor and electronically stored instructions, executable by the processor, for computationally generating responsive information for completing the transaction and causing the responsive information to be transmitted to the external device. In various embodiments, the controller may be configured to cause the responsive information to be transmitted via the at least one SPR antenna. In various embodiments, the controller may be configured to cause the responsive information to be transmitted via a cellular network interface. In various embodiments, the SPR antenna may be angled relative to a road surface. In various embodiments, the SPR antenna may be configured for diffractive transmission to the external device. In various embodiments, the external device may be one of a subsurface device beneath a road surface or a surface device on the road surface, and wherein the SPR antenna may be oriented normal to the road surface.

In another aspect, the invention relates to a method of vehicular navigation and transaction processing, the method may comprise the steps of: providing a surface-penetrating radar (SPR) system including at least one antenna; during vehicle travel, acquiring images with the SPR system; periodically determining a vehicle location using the SPR images; obtaining information via the SPR system from an external device that specifies a transaction; and generating responsive information for completing the transaction and causing the responsive information to be transmitted to the external device. In various embodiments, the responsive information may be transmitted via the at least one SPR antenna. In various embodiments, the responsive information may be transmitted via a cellular network interface. In various embodiments, the SPR antenna may be angled relative to a road surface. In various embodiments, the SPR antenna may be configured for diffractive transmission to the external device. In various embodiments, the external device may be one of a subsurface device beneath a road surface or a surface device on the road surface, and wherein the SPR antenna may be oriented normal to the road surface. In various embodiments, the SPR antenna may be configured to include a global positioning system (GPS) signal and a ground-penetrating radar (GPR) signal in a transmission to the external device. In various embodiments, the controller may require the presence of a verified user to complete the transaction. In various embodiments, the controller may confirm the presence of a verified user with a module disposed in the interior of the vehicle.

### BRIEF DESCRIPTION OF THE DRAWINGS

The foregoing summary, as well as the following detailed description of embodiments of the SPR system, will be better understood when read in conjunction with the appended drawings of an exemplary embodiment. It should be understood, however, that the invention is not limited to the precise arrangements and instrumentalities shown.

In the drawings:

FIG. 1 is a side view of a SPR system mounted to a vehicle in accordance with an exemplary embodiment of the present invention

FIG. 2 is a schematic representation of the SPR system of FIG. 1 in accordance with an exemplary embodiment of the present invention; and

FIG. 3 is a front view of the SPR system of FIG. 1 communicating with a transceiver in accordance with an exemplary embodiment of the present invention.

### DETAILED DESCRIPTION

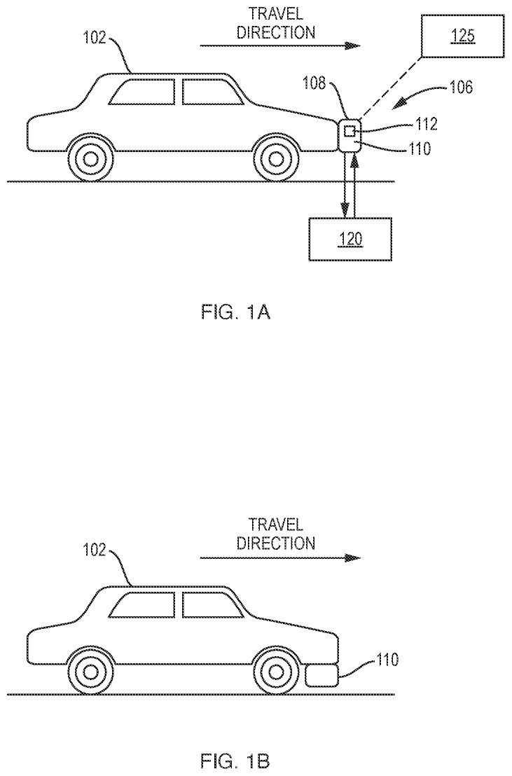

Referring first to FIG. 1, which depicts an exemplary vehicle 102 provided with a terrain-monitoring system 106 for vehicle navigation. In various embodiments, the terrain monitoring system 106 includes an SPR navigation and control system 108 having a GPR system 112 including a ground-penetrating radar (GPR) antenna array 110 fixed to the front (or any suitable portion) of the vehicle 102. The illustrated GPR antenna array 110 is generally oriented parallel to the ground surface and extends perpendicular to the direction of travel. In some configurations, the GPR antenna array 110 is closer to or in contact with the surface of the road (FIG. 1B). In one embodiment, the GPR antenna array 110 includes a linear configuration of spatially-invariant antenna elements for transmitting GPR signals to the road. For example, the GPR signals may propagate through the road surface into the subsurface region and be reflected in an upward direction. The reflected GPR signals can be detected by the receiving antenna elements in the GPR antenna array 110. In various embodiments, the detected GPR signals are then processed and analyzed in order to generate one or more SPR images (e.g., GPR images) of the subsurface region along the track of the vehicle 102. If the SPR antenna array 110 is not in contact with the surface, the strongest return signal received may be the reflection caused by the road surface. The SPR images may include surface data, e.g., data for the interface of the subsurface region with air or the local environment. Suitable GPR antenna configurations and systems for processing GPR signals are described, for example, in U.S. Pat. No. 8,949,024, the entire disclosure of which is hereby incorporated by reference.

In some aspects, to obtain localization information, the SPR images are compared to SPR reference images that were previously acquired and stored for subsurface regions that at least partially overlap the subsurface regions for the defined route. The image comparison may be a registration process based on, for example, correlation as described in U.S. Pat. No. 8,786,485, the entire disclosure of which is incorporated by reference herein. The location of the vehicle 102 and/or the terrain conditions of the predefined route can then be determined based on the comparison. In some embodiments, the detected GPR signals are combined with other real-time information, such as the weather conditions, electro-optical (EO) imagery, vehicle health monitoring using one or more sensors employed in the vehicle 102, and any suitable inputs, to estimate the terrain conditions of the predefined route. In one embodiment, to execute a payment transaction, the GPR antenna array interacts with a transceiver 120 located below, on or, in some implementations, flush with the surface of the road. As described in greater detail below, the SPR system 108 may be linked to a digital wallet 125 or other payment source or sources. The transceiver 120 may be embedded in a sealed enclosure within the road with a data and power transmission line connecting to a box. The box may include a RF transceiver able to emit and receive in the UHF or VHF bands. The data and power transmission line may connect to a broader network through a junction box located proximate to the road.

The GPR system 112 may be connected to a processor on the vehicle 102 with storage that includes a digital wallet including a unique ID code for the vehicle 102 or driver, as described in more detail below. The driver of the vehicle 102 can be identified through, for example, facial or biometric identification through a vehicle driver monitoring system, sensors embedded in the steering wheel, an app on a mobile device, or the interactive navigation and control display. The GPR system 112 may transmit a unique encrypted transaction code and ID code through the transceiver 120 to a remote server over the network that is aware of the transceiver connection to, for example, a restaurant drive though or toll location. The server may confirm there are funds available for the transaction to occur. The server may respond with the transaction information through the transceiver 120 and GPR system 112 to the user. The driver may approve the transaction on the user interface/screen of the vehicle 102 where appropriate. The vehicle then may transmit, through the GPR system 112 to the transceiver 120 and remote server that the transaction has been approved. The server may confirm the transaction with all remote entities and transmit a final receipt to the vehicle 102 to store in its digital wallet 125.

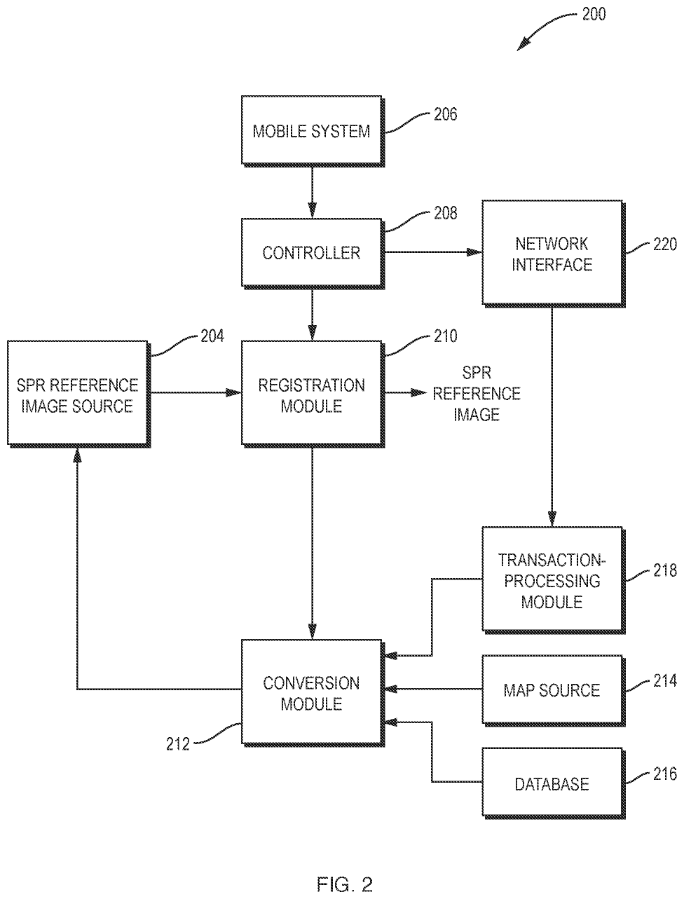

FIG. 2 depicts an exemplary SPR system 200 that facilitates both navigation and transaction processing. The SPR system 108 may also include a mobile SPR system (“Mobile System”) 206 having an SPR antenna array 110. The transmit operation of the mobile SPR system 206 may be controlled by a controller (e.g., a processor) 208 that also receives the return SPR signals detected by the mobile system 206. The controller 208 generates SPR images of the subsurface region below the road surface and/or the road surface underneath the SPR antenna array 110.

The SPR image includes features representative of structure and objects within the subsurface region and/or on the road surface, such as rocks, roots, boulders, pipes, voids and soil layering, and other features indicative of variations in the soil or material properties in the subsurface/surface region. In various embodiments, a registration module 210 compares the SPR images provided by the controller 208 to the SPR images retrieved from the SPR reference image source 204 to locate the vehicle 102 (e.g., by determining the offset of the vehicle with respect to the closest point on the route). The location information (e.g., offset data, or positional error data) determined in the registration process is provided to a conversion module 212 that creates a location map for navigating the vehicle 102 and a timestamped instantaneous vehicle location, which is continuously obtained and refreshed. For example, the conversion module 212 may generate an estimated location corrected for the vehicle positional deviation from the route. Suitable comparison through registration of prior and current measurements by the registration module is described, for example, in U.S. Patent Application Publication No. 2014/0121964, the entire disclosure of which is hereby incorporated by reference. The reference image may be a map and the map may be generated by, for example, a sensor map provider, a payment location transceiver owner, or an end user. Once obtained, the map may be stored on a remote server and loaded onto the vehicle 102 either ahead of a transaction or during the transaction.

Alternatively, the conversion module 212 may retrieve an existing map from a map source 214 (e.g., other navigation systems, such as GPS, or a mapping service), and then localize the obtained locational information to the existing map. In one embodiment, the location map of the predefined route is stored in a database 216 in system memory and/or a storage device accessible to the controller 208. Additionally or alternatively, the location data for the vehicle 104 may be used in combination with the data provided by an existing map (e.g., a map provided by GOOGLE MAPS) and/or one or more other sensors or navigation systems, such as an inertial navigation system (INS), a GPS system, a sound navigation and ranging (SONAR) system, a LIDAR system, a camera, an inertial measurement unit (IMU) and an auxiliary radar system, one or more vehicular dead-reckoning sensors (based on, e.g., steering angle and wheel odometry), and/or suspension sensors to guide the vehicle 102. For example, the controller 208 may localize the obtained SPR information to an existing map generated using GPS. Approaches for utilizing the SPR system for vehicle navigation and localization are described in, for example, the '024 patent mentioned above.

In addition, a transaction-processing module 218 of the controller 208 may be responsive, via at least a portion of the SPR antenna array 110 (or a separate antenna), to signals from transaction-processing sources such as a tolling sensor. The tolling sensor may be a receiver or transceiver. The tolling sensor may actively listen for encrypted signals from the GPR system 112 in the UHF/VHF frequency ranges. The signals may be encrypted and overlayed on top of the primary localization related emissions of the antennas of the GPR antenna array 110. The signals may be emitted separately or may be limited by the known location of the receiver. The toll server may then record the transaction in the remote account after decrypting the identification and location information in the signal.

Open-road tolling sensors may be passive, since the SPR system is typically active during travel. In some embodiments, the open-road tolling sensors may be active and issue “wake up” signals that initiate a transaction as the vehicle 102 approaches an overhead gantry, passes a roadside transmitter or travels over a surface or subsurface sensor (e.g., the transceiver 120). Passive sensors may have a higher error or miss rate as they rely on continual transmission of a signal from the GPR system 112. Use of passive sensors may open up communications between the SPR system 108 and the transceiver 120 to further attacks. For a location specific emission, the passive sensors may rely on vehicle location information from a known location in the map. It is also possible the GPR could detect the signature of the receiver box or a marker that would then signal the GPR system 112 to emit a signal. For other types of transactions, such as paying for parking or battery charging, the communication may be initiated by the driver of the vehicle 102 e.g., via an onboard application executed by the controller 208 and available to the driver via a dashboard interface or by means of an application deployed on a mobile device in communication with the controller 208. The transaction-processing module 218 of the controller 208 may communicate with a transponder 120 in a parking kiosk or charging station via the SPR system 108, providing sufficient account information to effectuate approval of the transaction and/or payment.

Communication with a surface or subsurface sensor (e.g., the transceiver 120) has the advantage of defense against spoofing, since the signal is difficult to detect maliciously, whereas communication with overhead or roadside sensors lacks this advantage. The use of subsurface sensors for receiving signals from the GPR system 112 to assure the vehicle 102 position substantially reduces the likelihood of spoofing, or other fraudulent activities. A receiver in a wrong location may be detected using known information, and a transaction request can be rejected by the GPR system 112 if a wrong location of the receiver is detected. The position of the vehicle 102 may be actively confirmed using the GPR system 112 to identify and confirm that the vehicle 102 is not near an approved toll or payment location to reject a transaction request. A vehicle attempting to perform a fraudulent transaction may need to know the specific encrypted ID, time, and location combination to spoof another vehicle at the toll location. Information may also be validated against other available information, such as a license plate, to confirm a match and prevent unintended transactions.

A remote verification system may signal to the GPR system 112 of the vehicle 102 that additional data is required to validate a transaction request, for example, if a comparison of the map generated by the GPR system 112 and the existing map segment, as described above, produces multiple alternative location matches or is otherwise ambiguous. If the validity of a transaction request is unable to be verified using the map comparison described above, the position of the vehicle 102 may be confirmed using the GPR system 112 by generating a larger subsurface map. The GPR system 112 may generate a map having a greater width, greater length, and/or greater depth than that described above when generating a larger subsurface map. The GPR system 112 may provide the remote verification system with, for example, an additional 100 feet of generated map. Progressively larger subsurface maps may be provided by the GPR system 112 to the remote verification system until the location can be accurately validated. Comparing the larger subsurface maps with existing maps may increase the accuracy and security of transaction and location validation.

Still, such overhead or roadside sensor arrangements may be preferred or acceptable in various applications if adequate security can be ensured. To implement them in the present context, measures may be taken to enable a downwardly oriented GPR antenna array 110 to communicate with much higher signal sources. One approach is to angle one or more of the GPR antennas relative to the ground so that reflected signals can reach the overhead gantry or a roadside receiver. The reflection may be enhanced by an RF-reflective plate embedded in the roadway surface.

The RF-reflective plate may be approximately 6 feet wide. The RF-reflective plate may be approximately 3 feet wide. The RF-reflective plate may be approximately 3.5 feet wide. The RF-reflective plate may be approximately 4 feet wide. The RF-reflective plate may be approximately 4.5 feet wide. The RF-reflective plate may be approximately 5 feet wide. The RF-reflective plate may be approximately 5.5 feet wide. The RF-reflective plate may be approximately 6.5 feet wide. The RF-reflective plate may be approximately 7 feet wide. The RF-reflective plate may be approximately 7.5 feet wide. The RF-reflective plate may be approximately 8 feet wide. The RF-reflective plate may be approximately 8.5 feet wide. The RF-reflective plate may be approximately 9 feet wide. The RF-reflective plate may be approximately 10 feet wide. The RF-reflective plate may be approximately 15 feet wide. The RF-reflective plate may be approximately 20 feet wide. The RF-reflective plate may be approximately 30 feet wide. The RF-reflective plate may be approximately 40 feet wide.

The RF-reflective plate may be up to 6 feet wide. The RF-reflective plate may be up to 3 feet wide. The RF-reflective plate may be up to 3.5 feet wide. The RF-reflective plate may be up to 4 feet wide. The RF-reflective plate may be up to 4.5 feet wide. The RF-reflective plate may be up to 5 feet wide. The RF-reflective plate may be up to 5.5 feet wide. The RF-reflective plate may be up to 6.5 feet wide. The RF-reflective plate may be up to 7 feet wide. The RF-reflective plate may be up to 7.5 feet wide. The RF-reflective plate may be up to 8 feet wide. The RF-reflective plate may be up to 8.5 feet wide. The RF-reflective plate may be up to 9 feet wide. The RF-reflective plate may be up to 10 feet wide. The RF-reflective plate may be up to 15 feet wide. The RF-reflective plate may be up to 20 feet wide. The RF-reflective plate may be up to 30 feet wide. The RF-reflective plate may be up to 40 feet wide.

The RF-reflective plate may be approximately 4 feet long. The RF-reflective plate may be approximately 2 feet long. The RF-reflective plate may be approximately 2.5 feet long. The RF-reflective plate may be approximately 3 feet long. The RF-reflective plate may be approximately 3.5 feet long. The RF-reflective plate may be approximately 4.5 feet long. The RF-reflective plate may be approximately 5 feet long. The RF-reflective plate may be approximately 5.5 feet long. The RF-reflective plate may be approximately 6 feet long. The RF-reflective plate may be approximately 7 feet long. The RF-reflective plate may be approximately 8 feet long. The RF-reflective plate may be approximately 9 feet long. The RF-reflective plate may be approximately 10 feet long. The RF-reflective plate may be approximately 15 feet long. The RF-reflective plate may be approximately 20 feet long. The RF-reflective plate may be approximately 25 feet long. The RF-reflective plate may be approximately 30 feet long.

The RF-reflective plate may be up to 4 feet long. The RF-reflective plate may be up to 2 feet long. The RF-reflective plate may be up to 2.5 feet long. The RF-reflective plate may be up to 3 feet long. The RF-reflective plate may be up to 3.5 feet long. The RF-reflective plate may be up to 4.5 feet long. The RF-reflective plate may be up to 5 feet long. The RF-reflective plate may be up to 5.5 feet long. The RF-reflective plate may be up to 6 feet long. The RF-reflective plate may be up to 7 feet long. The RF-reflective plate may be up to 8 feet long. The RF-reflective plate may be up to 9 feet long. The RF-reflective plate may be up to 10 feet long. The RF-reflective plate may be up to 15 feet long. The RF-reflective plate may be up to 20 feet long. The RF-reflective plate may be up to 25 feet long. The RF-reflective plate may be up to 30 feet long.

The RF-reflective plate may be a metal plate. The RF-reflective plate may be on or in the road surface, located partially laterally offset to the path of the vehicle to enhance reflections towards an overhead or side transceiver 120 (or receiver). The GPR antenna array 110 may be constructed to produce enough diffraction around the edges of the array 110 to allow the signals to be exchanged with an external receiver (e.g., transceiver 120). In one embodiment, the SPR system 108 may transmit a GPR signal in addition to listening to a GPS signal (through a GPS receiver already in the vehicle) to reduce the likelihood of spoofing. The SPR system 108 may listen to the GPS signal. By using this multisensory fused variant, the SPR system can increase the amount of identifiable data that is received by the transceiver 120 In one embodiment, the SPR system may modulate the frequency of the GPR signal to increase the unique characteristics of the transmitted signal. The transmitted signal may include an extended path or length of data to add increased identifiable and unique characteristics to reduce the likelihood of spoofing. In still another approach, the transaction is completed via a different communication modality (e.g., the vehicle's cellular data system or other network interface 220).

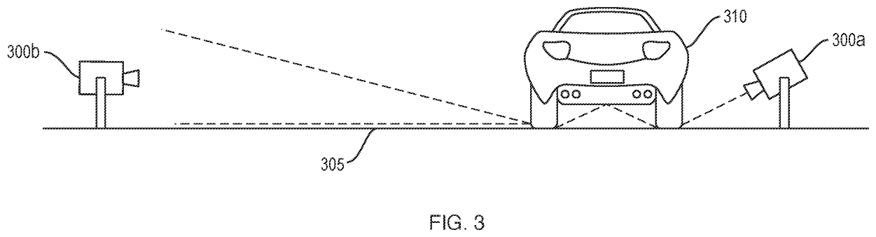

With reference to FIG. 3, a pair of transceivers 300a, 300b are located on opposite sides of a roadway 305. Transceivers 300a, 300b may be overhead transceivers located generally above the vehicle 310 on the roadway 305. Transceivers 300a, 300b located overhead may provide sufficient clearance for vehicle 310 to travel underneath without interfering with the course of travel. When a vehicle 310 approaches, the transceiver 300a may direct a radio frequency signal at the GPR operating frequency toward the roadway 305, angled so that the beam will reflect and be received by a GPR antenna of the vehicle 310. As described above, in some embodiments, a metal plate is embedded into or affixed to the roadway 305 between the transceivers 300a, 300b to enhance reflection of the radar signal. The metal plate may be covered with asphalt to ensure a consistent road surface as the vehicle 310 passes over the subsurface transceiver 120. The metal plate may be covered by any surface over which a vehicle 310 may travel, such as, for example, asphalt, concrete, dirt, and gravel.

The controller 208 of the SPR system 200 (FIG. 2) of the vehicle 310 may receive information extracted from the received signal and responsively generate data to complete a transaction. The controller 208 may then cause this generated data to be transmitted to either or both transceivers 300a, 300b via a similar path using a radar signal. That is, one or more left-angled antennas on the vehicle's left side may communicate with the transceiver 300b and/or one or more right-angled antennas on the vehicle's right side may communicate with the transceiver 300a. Validation of the radar signals received by the transceivers 300a, 300b may include one or more stages of proof to prevent spoofing. This validation may include verification of any or all of the GPR signal, GPS signal, and/or a visual marker of the transceivers 300a, 300b. The received signals may be processed through an encrypted communication channel or network to verify the validity before a transaction can be completed. For example, a GPR signature transmitted by a GPR antenna of the vehicle 310 may be used to automatically generate a message that is encrypted by a private or public key for encrypted communication when approaching the transceivers 300a, 300b. It may be possible that a particular signature or other position information is used to generate the encryption key as well.

The controller 208 may require detection of the presence of a verified user prior to completing a transaction. For example, a sensor located on the interior of the vehicle 310 may sense the presence of a verified user by identifying a key fob or RFID chip, performing facial recognition, or receiving a RF signature of a verified user. Upon confirming the presence of a verified user, the controller 208 may complete the transaction.

Location information supplied by the mobile SPR system 206 can be used as part of the transactional information exchange. SPR information can, for example, establish the space a vehicle occupies in a large parking lot.

The controller 208 may include one or more modules implemented in hardware, software, or a combination of both. For embodiments in which the functions are provided as one or more software programs, the programs may be written in any of a number of high level languages such as PYTHON, FORTRAN, PASCAL, JAVA, C, C++, C #, BASIC, various scripting languages, and/or HTML. Additionally, the software can be implemented in an assembly language directed to the microprocessor resident on a target computer; for example, the software may be implemented in Intel 80×86 assembly language if it is configured to run on an IBM PC or PC clone. The software may be embodied on an article of manufacture including, but not limited to, a floppy disk, a jump drive, a hard disk, an optical disk, a magnetic tape, a PROM, an EPROM, EEPROM, field-programmable gate array, or CD-ROM. Embodiments using hardware circuitry may be implemented using, for example, one or more FPGA, CPLD or ASIC processors.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. Finally, unless specifically set forth herein, a disclosed or claimed method should not be limited to the performance of their steps in the order written, and one skilled in the art can readily appreciate that the steps may be performed in any practical order.

What is claimed is:

1. A vehicle-borne system comprising:
a surface-penetrating radar (SPR) system for acquiring SPR images including at least one antenna configured for RF communication with an external device;
a transaction module for obtaining information via the SPR system from the external device specifying a transaction; and
a controller including a processor and electronically stored instructions, executable by the processor, for computationally generating responsive information for completing the transaction and causing the responsive information to be transmitted to the external device.

2. The system of claim 1, wherein the controller is configured to cause the responsive information to be transmitted via the at least one SPR antenna.

3. The system of claim 1, wherein the controller is configured to cause the responsive information to be transmitted via a cellular network interface.

4. The system of claim 1, wherein the SPR antenna is angled relative to a road surface.

5. The system of claim 1, wherein the SPR antenna is configured for diffractive transmission to the external device.

6. The system of claim 1, wherein the external device is one of a subsurface device beneath a road surface or a surface device on the road surface, and
wherein the SPR antenna is oriented normal to the road surface.

7. A method of vehicular navigation and transaction processing, the method comprising the steps of:
providing a surface-penetrating radar (SPR) system including at least one antenna;
during vehicle travel, acquiring images with the SPR system;
periodically determining a vehicle location using the SPR images;
obtaining information via the SPR system from an external device that specifies a transaction; and
generating responsive information for completing the transaction and causing the responsive information to be transmitted to the external device.

8. The method of claim 7, wherein the responsive information is transmitted via the at least one SPR antenna.

9. The method of claim 7, wherein the responsive information is transmitted via a cellular network interface.

10. The method of claim 7, wherein the SPR antenna is angled relative to a road surface.

11. The method of claim 7, wherein the SPR antenna is configured for diffractive transmission to the external device.

12. The method of claim 7, wherein the external device is one of an overhead device above a road surface, a subsurface device beneath the road surface or a surface device on the road surface, and
wherein the SPR antenna is oriented normal to the road surface.

13. The system of claim 1, wherein the SPR antenna is configured to include a global positioning system (GPS) signal and a ground-penetrating radar (GPR) signal in a transmission to the external device.

14. The system of claim 1, wherein the controller requires the presence of a verified user to complete the transaction.

15. The system of claim 14, wherein the controller confirms the presence of a verified user with a module disposed in the interior of the vehicle.
